(19) United States
(12) Patent Application Publication
(10) Pub. No.: US 2020/0044334 A1
(43) Pub. Date: Feb. 6, 2020

(54) MICROWAVE ANTENNA CONTROL SYSTEM

(71) Applicant: Rosenberger Technologies Co., Ltd., Kunshan City (CN)

(72) Inventors: Junaid SYED, Dianshanhu Town (CN); Daobing PENG, Dianshanhu Town (CN)

(73) Assignee: Rosenberger Technologies Co., Ltd., Kunshan City (CN)

(21) Appl. No.: 16/585,273

(22) Filed: Sep. 27, 2019

Related U.S. Application Data
(63) Continuation-in-part of application No. PCT/CN2018/078114, filed on Mar. 6, 2018.

(30) Foreign Application Priority Data
Mar. 28, 2017 (CN) 201710189820.3
Mar. 6, 2018 (CN) PCT/CN2018/078114

(51) Int. Cl. H01Q 3/08; H01Q 1/12; G01C 9/12

(52) U.S. Cl. CPC H01Q 3/08; H01Q 15/14; G01C 9/12; H01Q 1/125

(57) ABSTRACT

The invention discloses a microwave antenna control system used for automatically adjusting boresight alignment of a microwave antenna. The microwave antenna control system comprises a first driving device, a second driving device, an inclination angle sensor and a control unit, wherein the first driving device, the second driving device and the inclination angle sensor are connected with the microwave antenna and are also connected with the control unit, The inclination angle sensor monitors angular alignment information of the microwave antenna, and the control unit controls the first driving device and/or the second driving device to accurately and automatically adjust the boresight alignment of the microwave antenna according to the angle information.

### FIELD OF THE INVENTION

The present invention relates to a device for adjusting a boresight alignment of a directional antenna, and more particularly to a motorized control system with an inclination angle sensor for remotely/automatically adjusting the boresight alignment of a microwave antenna.

### BACKGROUND

Antennas, such as reflector antennas for terrestrial microwave communication systems, may be highly directional. To maximize electrical performance, the antenna mount of an antenna assembly may be finely adjustable for ease of obtaining a boresight alignment between antenna pairs forming an RF communications link.

The antenna mount should maintain the selected alignment despite exposure over time to weather induced wind and/or ice loads acting upon the antenna assembly that, depending upon the installation location, may rise to extreme levels during storms. As a distance to the target antenna increases, even very small alignment shifts may become significant. Should the antenna mount lose the desired boresight alignment, for example due to transient wind and/or ice loads, communications relying on the antenna pair may be disrupted and a significant delay and/or expense can be incurred by the return of a human resource to a remote location such as atop a remote structure or radio tower, to repeat the alignment procedure.

Minimizing the wind load of an antenna assembly reduces the chances for weather induced direction errors and/or reduces structural requirements of the antenna mount and/or antenna mounting points.

In the prior art, the boresight alignment of an antenna is typically performed on site via climbing to the antenna location with tools, direction indicators and local communications to manually align each of the antennas of a communications link, consuming time and expensive highly trained human resources. The prior boresight alignment process is complicated, expensive and exposes the human resources to dangerous heights.

Prior antenna mounting procedures may include precise alignment with respect to a vertical and/or horizontal reference plane. These procedures add additional steps and therefor additional time and expense to the installation of an antenna. Further, where strong winds occur, the mounting point itself may be subject to significant sway after the antenna installation has been completed.

Competition in the antenna market has focused attention on improving alignment stability and ease of alignment adjustment while also minimizing overall manufacturing, inventory, distribution, installation and maintenance costs. Therefore, it is an object of the invention to provide a reflector antenna mount/microwave antenna control system that overcomes deficiencies in the prior art.

### SUMMARY OF THE INVENTION

The present invention is intended to overcome the defects in the prior art and provides a microwave antenna control system for automatically adjusting the boresight alignment of an antenna.

In order to achieve the object above, the present invention provides the following technical solutions. A microwave antenna control system comprises:

a first driving device connected with a microwave antenna and used for driving the microwave antenna to rotate in a vertical direction;

a second driving device connected with the microwave antenna and used for driving the microwave antenna to rotate in a horizontal direction;

an inclination angle sensor positioned upon the microwave antenna sensing angles of the microwave antenna in vertical and horizontal directions; and

a control unit receiving angular position inputs from the inclination angle sensor; the control unit also connected with both the first driving device and the second driving device and used for respectively controlling the first driving device and the second driving devices to achieve and/or maintain a desired antenna boresight alignment.

Preferably, the first driving device comprises a first motor, a driving gear and a driving wheel meshed with the driving gear, the driving gear is arranged on an output shaft of the first motor, and the driving wheel is fixedly connected with the microwave antenna.

Preferably, the second driving device comprises a second motor, a supporting member and a horizontal rotating shaft, the second motor is fixedly connected with the microwave antenna through the supporting member, the horizontal rotating shaft is arranged on the supporting member, and the second motor drives the microwave antenna to rotate around the horizontal rotating shaft in the horizontal direction.

Preferably, the microwave antenna is connected with the first driving device and the second driving device through a reflector carriage.

Preferably, the first driving device further comprises a vertical rotating shaft, the vertical rotating shaft passes through the reflector carriage, and the first driving device drives the microwave antenna to rotate around the vertical rotating shaft in the vertical direction.

Preferably, the microwave antenna control system further comprises a guide device, wherein the guide device is connected with the second driving device and used for guiding the microwave antenna to rotate in the vertical direction.

Preferably, the guide device comprises a guide rod and a guide groove, the guide rod is fixedly connected with the microwave antenna, the guide groove is arranged on the supporting member, and the guide rod seats within and moves along the guide groove.

Preferably, the control unit is in wired connection with both the first driving device and the second driving device.

Compared with the prior art, the automatic adjustment of the angle of the antenna is realized by arranging a structure for adjusting a boresight alignment of the antenna according to the present invention, and the present invention has reduced structural requirements and is easy to install, operate, and can accurately adjust the boresight alignment of the antenna without requiring the repeated presence of a human resource at the antenna mounting point.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic isometric back view of an exemplary antenna control system according to the present invention.

FIG. 2 is a schematic isometric front view of the antenna control system of FIG. 1.

FIG. 3 is another schematic isometric back view of the antenna control system of FIG. 1.

FIG. 4 is a schematic isometric view of the supporting member of the antenna control system of FIGS. 1-3.

FIG. 5 is a simplified schematic diagram of an inclination angle sensor.

FIG. 6 is a simplified schematic diagram of a dual axis inclination angle sensor.

### DETAILED DESCRIPTION

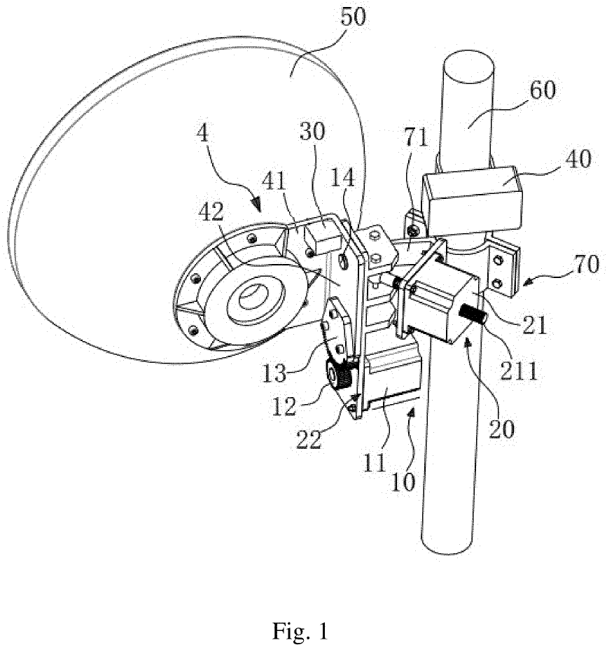

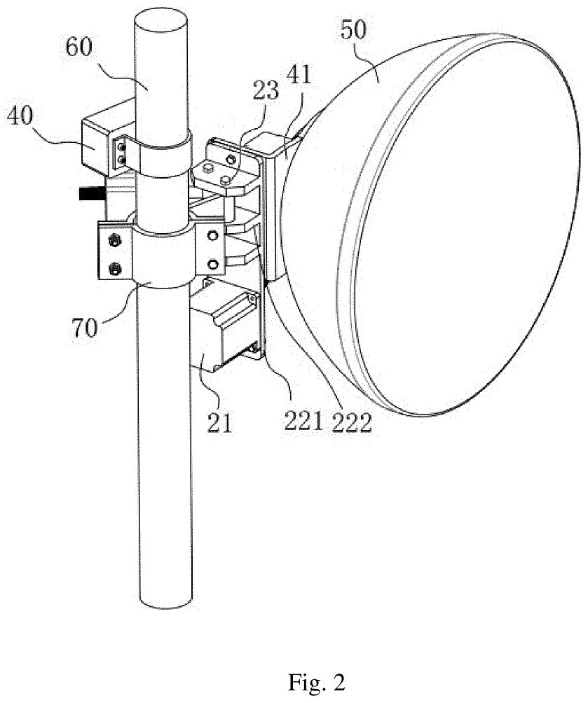

The inventors have recognized that antenna control systems may be significantly improved by utilizing an inclination angle sensor, instead of multiple conventional angle sensors measuring deviation from a reference plane of the assembly mounting point. With reference to FIGS. 1-3, a microwave antenna control system comprises a first driving device 10, a second driving device 20, an inclination angle sensor 30 and a control unit 40. The first driving device 10, the second driving device 20 and the inclination angle sensor 30 are each connected with a microwave antenna 50 and are each connected with the control unit 40.

The inclination angle sensor 30 is used for monitoring angle information of the microwave antenna 50, independent of the mounting structure utilized, and the control unit 40 controls the first driving device 10 and/or the second driving device 20 to automatically adjust an angle of the microwave antenna 50 according to the angle information received from the inclination angle sensor 30.

The microwave antenna 50 is connected with the first driving device 10 and the second driving device 20 through a reflector carriage 4. The reflector carriage 4 comprises a first fixing plate 41 and a second fixing plate 42 which are provided at right angles to each other. The first fixing plate 41 is fixedly connected with the microwave antenna 50 while the second fixing plate 42 pivots with respect to a supporting member 22.

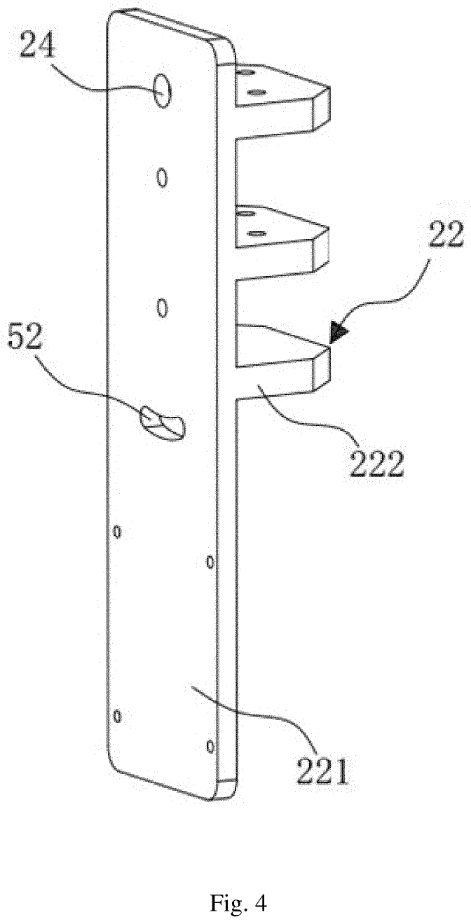

As best shown in FIG. 4, the supporting member 22 comprises a third fixing plate 221 and at least one support bracket 222. The third fixing plate 221 has two sides, one of the two sides is adjacent to and rotatably fixed with the second fixing plate 42 as described herein above. The support bracket 222 is provided extending from the other side of the third fixing plate 221 vertically and outwardly, and a certain interval is arranged between every two adjacent support brackets 222.

The first driving device 10 is used for driving the microwave antenna 50 to rotate along a vertical plane and comprises a first motor 11 with an output shaft upon which a driving gear 12 is fixed. The driving gear 12 meshes with a driving wheel 13 mounted upon the second fixing plate 42. The first motor 11 is fixedly installed on the third fixing plate 221 of the supporting member 22. The second fixing plate 42 of the reflector carriage 4 and the supporting member 22 are provided with corresponding vertical shaft holes 24 through which a vertical rotating shaft 14 is seated. As the output shaft of the motor 11 rotates the driving gear 12, the driving gear 12 rotates the driving wheel 13, thereby rotating the second fixing plate 42 and thus the antenna 50 about the vertical rotating shaft 14, realizing automatic adjustment of the angle of the microwave antenna 50 in a vertical plane.

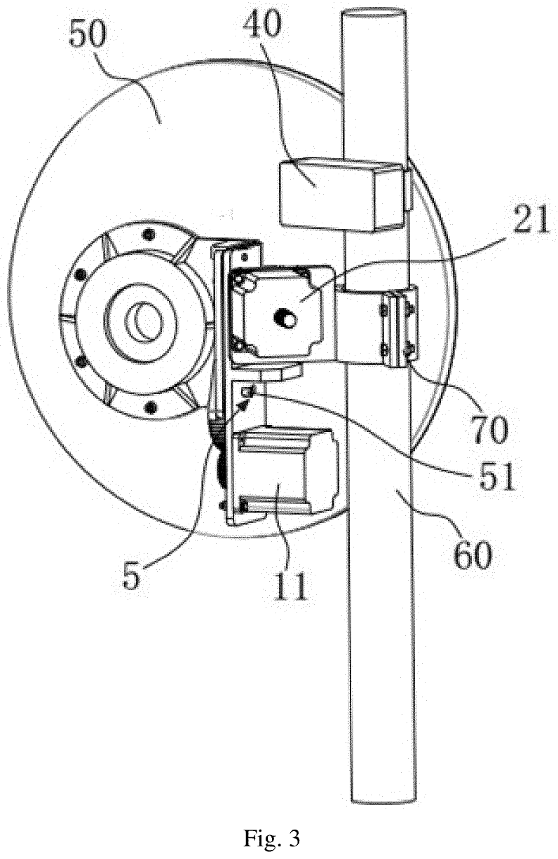

The angular range of movement may be limited via application of a guide device 5. The vertical rotating angle range may be, for example, approximately +/−15 degrees (taking a horizontal plane as a rotating reference plane). Where the vertical rotating angle range is significantly less than 360 degrees, the driving wheel 13 may be provided as an arc segment of a wheel (see FIG. 1), reducing the required size and machining complexity of the driving wheel 13. Specifically, with reference to FIG. 3 and FIG. 4, a guide device 5 may comprise, for example, a guide rod 51 and a guide groove 52. The guide groove 52 is arranged on the third fixing plate 221 of the supporting member 22. One end of the guide rod 51 is fixedly connected with the second fixing plate 42 of the reflector carriage 4, i.e., the guide rod 51 is formed by extending vertically and outwardly from one side of the second fixing plate 42 which is attached to the third fixing plate 221, and the other end of the guide rod 51 movably seats within the guide groove 52 and moves along an inner edge of the guide groove 52 in the guide groove 52. The guide groove 52 is distributed on the third fixing plate 221 in a lateral direction (the lateral direction referred to herein is the lateral direction shown in the drawing), and the guide groove 52 is arc-shaped with the center of rotation at the vertical rotating shaft 14, where the extent of the arc length sets the vertical rotating angle range.

As best shown in FIG. 1, a mounting structure carriage 70, such as a clamp or frame member is used for fixing the microwave antenna 50 securely upon the desired mounting structure 60, such as a pole, tower or building. The mounting structure carriage 70 extends outwardly to form a carriage extension portion 71, the carriage extension portion 71 is rotatably connected with the supporting member 22 via a horizontal rotating shaft 23 secured between two support bracket 222 of the supporting member 22, the rotating shaft 23 passing through the carriage extension portion 71.

The second driving device 20 is used for driving the microwave antenna 50 to rotate in a horizontal plane about the horizontal rotating shaft 23. The second motor 21 is mounted upon the mounting structure carriage 70. The second motor 21 has a driving shaft 211, at least a middle portion of the driving shaft 211 is threaded, and the driving shaft 211 is fixedly connected to the supporting member 22 between supporting brackets 222, spaced away from the connection point of the horizontal rotating shaft 23. The second motor 21 rotation threads the driving shaft 211 in and out of the second motor 21 causing the driving shaft 211 to be pulled/extended back and forth during operation, thus driving the microwave antenna 50 to perform angle adjustment in the horizontal plane about the horizontal rotating shaft 23.

The control unit 40 may be fixed, for example as shown in FIG. 3, on the mounting structure 60 or mounting structure carriage 70 through a corresponding fixing member, the control unit 40 may be in wired connection with the first driving device 10 and the second driving device 20. Alternatively, other communication connection modes such as wireless communication may be applied. Further, the control module 40 may be integrated with the inclination angle sensor 30 to provide a single environmentally sealed module.

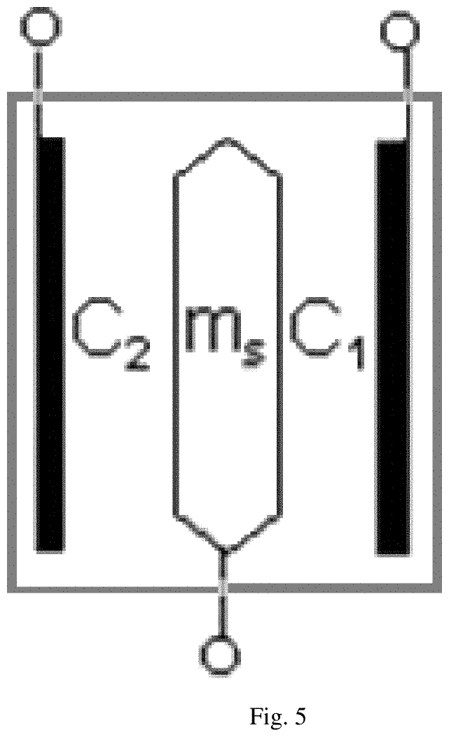

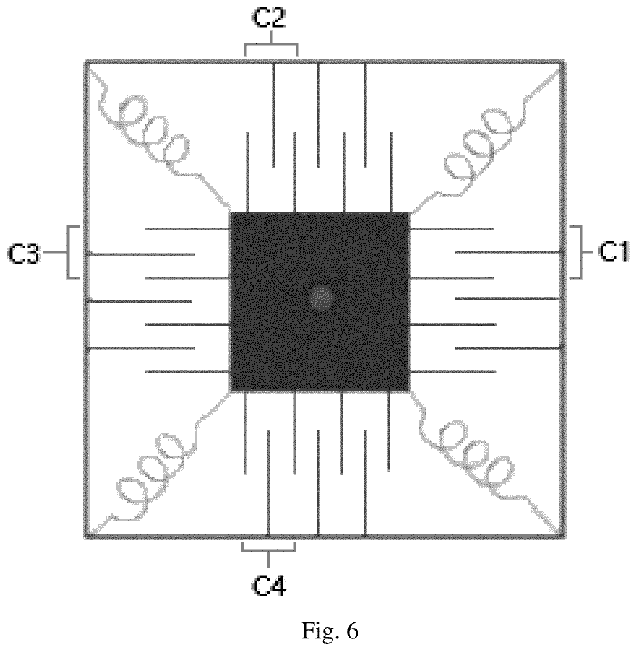

The inclination angle sensor 30 provides the control unit 40 with inputs corresponding to the angular orientation of the inclination angle sensor 30 and thus of the microwave antenna 50 it is coupled to. The inclination angle sensor 30 may be, for example as shown in FIG. 5, a micro-electro-mechanical-system (MEMS) utilizing a suspended electrode provided as a spring suspended mass ms disposed between fixed electrodes C₁ and C₂ of a capacitor. Any inclination of the MEMS assembly causes a drift of the suspended electrode, resulting in a measurable change in differential capacitance. Applying additional capacitive surfaces and/or applying surfaces with respect to alternative axes, enables generation of higher resolution multi-axis angular orientation inclination angle sensors, for example as shown in FIG. 6. Contrary to conventional angle sensors, an inclination angle sensor 30 has no optical, mechanical or electrical sensing linkage to the antenna alignment mechanical (shaft position, rotation encoding) or electrical (pulse counting) structures, instead deriving the positional output while entirely self-contained, with respect to a mounting surface connection to the antenna mount. Therefore, the inclination angle sensor 30 for both the vertical and horizontal axes may be provided as a single environmentally sealed module, for example, coupled to the first and/or second fixing plate 41, 42 as best shown in FIG. 1.

One skilled in the art will appreciate that use of an inclination angle sensor 30, instead of a conventional angle sensor/shaft angle encoder/detector common in the prior art provides manufacturing, installation, environmental sealing and wind load benefits. With respect to manufacturing, design of the system is simplified as only a single inclination angle sensor module is required. This eliminates duplicate angle encoders/decoders and associated mounting and communications considerations, significantly simplifying manufacturing requirements. With respect to installation, the prior requirement for precise installation with respect to a reference angle while exposed to dangerous heights at the installation point is eliminated via use of the inclination angle sensor as the inclination angle sensor equipped system can self-level via the inclination angle sensor outputs. Further, should the mounting point orientation shift over time, the inclination angle sensor equipped system can again self-level in real time, without requiring another visit from a human resource up to the mounting point. With respect to environmental sealing, the self-contained and sealed inclination angle sensor module eliminates the need for complex environmental sealing of shaft/decoder wheel angle type encoders/decoders. Similarly, the ease of environmental sealing further reduces the overall wind load characteristic of the resulting assembly, as the need for a large radome surrounding the entire alignment drive system, instead of just the reflector dish face, is eliminated.

Table of Parts

| | |
|---|---|
| 4 | reflector carriage |
| 5 | guide device |
| 10 | first driving device |
| 11 | first motor |
| 12 | driving gear |
| 13 | driving wheel |
| 14 | vertical rotating shaft |
| 20 | second driving device |
| 21 | second motor |
| 211 | driving shaft |
| 22 | supporting member |
| 221 | third fixing plate |
| 222 | support bracket |
| 23 | horizontal rotating shaft |
| 24 | vertical rotating shaft installation hole |
| 30 | inclination angle sensor |
| 40 | control unit |
| 50 | microwave antenna |
| 41 | first fixing plate |
| 42 | second fixing plate |
| 51 | guide rod |
| 52 | guide groove, |
| 60 | mounting structure |
| 70 | mounting structure carriage |
| 71 | carriage extension portion |

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A microwave antenna control system, comprising:
a first driving device connected with a microwave antenna and used for driving the microwave antenna to rotate in a vertical direction;
a second driving device connected with the microwave antenna and used for driving the microwave antenna to rotate in a horizontal direction;
a control unit connected with both the first driving device and the second driving device and used for respectively controlling the first driving device and the second driving device to drive; and
an inclination angle sensor connected with the control unit and used for monitoring angles of the microwave antenna in vertical and horizontal directions and transmitting angle information to the control unit.

2. The microwave antenna control system according to claim 1, wherein the first driving device comprises a first motor, a driving gear and a driving wheel meshed with the driving gear; the driving gear is arranged on an output shaft of the first motor, and the driving wheel is fixedly connected with the microwave antenna.

3. The microwave antenna control system according to claim 2, wherein the driving wheel is provided as an arc segment of a wheel.

4. The microwave antenna control system according to claim 1, wherein the second driving device comprises a second motor, a supporting member and a horizontal rotating shaft, the second motor is fixedly connected with the microwave antenna through the supporting member, the horizontal rotating shaft is arranged on the supporting member, and the second motor drives the microwave antenna to rotate around the horizontal rotating shaft in the horizontal direction.

5. The microwave antenna control system according to claim 1, wherein the microwave antenna is connected with the first driving device and the second driving device through a reflector carriage.

6. The microwave antenna control system according to claim 5, wherein the first driving device further comprises a vertical rotating shaft, the vertical rotating shaft passes through the reflector carriage, and the first driving device drives the microwave antenna to rotate around the vertical rotating shaft in the vertical direction.

7. The microwave antenna control system according to claim 2, further comprising a guide device, wherein the guide device is connected with the second driving device and used for guiding the microwave antenna to rotate in the vertical direction.

8. The microwave antenna control system according to claim 7, wherein the guide device comprises a guide rod and a guide groove, the guide rod is fixedly connected with the microwave antenna, the guide groove is arranged on a supporting member, and the guide rod movably stretches into the guide groove, an arc length of the guide groove operative as an angular limit of the microwave antenna rotation in the vertical direction.

9. The microwave antenna control system according to claim 4, further comprising a mounting structure carriage for fixing the microwave antenna to a mounting structure, wherein the mounting structure carriage is connected with the horizontal rotating shaft, and the horizontal rotating shaft rotates around the mounting structure carriage.

10. The microwave antenna control system according to claim 1, wherein the control unit is in wired connection with both the first driving device and the second driving device.

11. The microwave antenna control system according to claim 1, wherein the inclination angle sensor is a single environmentally sealed module.

12. The microwave antenna control system according to claim 1, wherein the inclination angle sensor is a micro-electro-mechanical-system inclination angle sensor.

13. The microwave antenna control system according to claim 1, wherein the inclination angle sensor senses changes in differential capacitance responsive to angular changes of the sensor.

14. The microwave antenna control system according to claim 1, wherein the inclination angle sensor includes a weight suspended between fixed electrodes of a capacitor.

15. A microwave antenna control system, comprising:
a first driving device connected with a microwave antenna and used for driving the microwave antenna to rotate in a vertical direction;
the first driving device comprising a first motor, a driving gear and a driving wheel meshed with the driving gear, the driving gear is arranged on an output shaft of the first motor, and the driving wheel is fixedly connected with the microwave antenna;
a second driving device connected with the microwave antenna and used for driving the microwave antenna to rotate in a horizontal direction;
the second driving device comprising a second motor, a supporting member and a horizontal rotating shaft, the second motor is fixedly connected with the microwave antenna through the supporting member, the horizontal rotating shaft is arranged on the supporting member, and the second motor drives the microwave antenna to rotate around the horizontal rotating shaft in the horizontal direction;
a control unit connected with both the first driving device and the second driving device and used for respectively controlling the first driving device and the second driving device to drive; and
an inclination angle sensor connected with the control unit and used for monitoring angles of the microwave antenna in vertical and horizontal directions and transmitting angle information to the control unit.

16. The microwave antenna control system of claim 15, wherein the inclination angle sensor is a single environmentally sealed module.

17. The microwave antenna control system of claim 15, wherein the inclination angle sensor is a micro-electro-mechanical-system inclination angle sensor.

18. The microwave antenna control system according to claim 15, wherein the inclination angle sensor senses changes in differential capacitance responsive to angular changes of the sensor.

19. The microwave antenna control system according to claim 15, wherein the inclination angle sensor includes a weight suspended between fixed electrodes of a capacitor.
